(19) United States
(12) Patent Application Publication
(10) Pub. No.: US 2005/0060490 A1
(43) Pub. Date: Mar. 17, 2005

(54) Apparatus for multiple host access to storage medium

(76) Inventor: Wei-Chi Lu, Taipei City (TW)

Correspondence Address: Michael D. Bednarek;Shaw Pittman LLP, 1650 Tysons Boulevard, McLean, VA, 22102, US

(21) Appl. No.: 10/822,784

(22) Filed: Apr. 13, 2004

(30) Foreign Application Priority Data
Sep. 2, 2003 (TW) 092124235

(51) Int. Cl. G06F 12/00

(52) U.S. Cl. 711/115; 710/313

(57) ABSTRACT

An apparatus for multiple host access to a storage medium from a first and a second hosts, comprising a first and a second hot swap/hot plug interfaces for respectively interfacing to the first and the second hosts and a storage interface for interfacing to the storage medium. The apparatus is controlled so that, when only one of the first and the second host is effectively interfaced with the apparatus, the storage medium is appended to the effectively interfaced host and the apparatus provides access to the storage medium from the effectively interfaced host, and when both the first and the second hosts are effectively interfaced with the apparatus, the storage medium is appended to one of the first and the second hosts and the apparatus provides bridging between the first and the second hosts as well as access to the storage medium from both the first and the second hosts.

### BACKGROUND OF THE INVENTION

1. Field of the Invention

The present invention relates to a hot swap/hot plug device, and, more particularly, to a hot swap/hot plug data storage and data transfer device.

2. Description of the Related Art

Thanks to the development of hot swap/hot plug interface technologies such as USB (Universal Serial Bus) and IEEE 1394, Plug-and-Play (PnP) devices have rapidly become widespread. A Plug-and-Play (PnP) device can be automatically installed to or uninstalled from a host when a connection between the device and the host is established or cut off, without the need of shutting down and restarting the host and the need of installing a driver program separately. Such Plug-and-Play devices significantly increase convenience of hardware usage. In addition, development of small-sized connectors allows the hot swap/hot plug interfaces to be applied to not only computers and servers, but also portable digital devices such as a PDA (Personal Digital Assistant) and a cellular phone.

Taking USB protocol for example, in a typical USB system, there is only one USB host, in which a root hub is provided to allow connection of plural USB devices. A USB mini drive, which is now broadly used as a portable data storage device, is a device with a USB interface. FIG. 1 shows the connection between a USB data storage device 12 and a USB host 10. The USB data storage device 12 mainly comprises a storage medium 16 and a USB connection interface 14, through which the storage medium 16 may be connected to the USB host 10. The storage medium 16 is usually, for example, a mass storage device such as a flash memory, and the USB host 10 is usually a data processing apparatus such as a personal computer. Because of the Plug-and-Play feature of the USB interface, together with the small size and large storage capacity characteristics of the flash memory, the USB mini drive has, in place of a traditional floppy disk, become the most popular portable storage device.

In addition to the above described USB device for connecting to one USB host, a USB bridge device for interconnecting two USB hosts, such as disclosed in R.O.C. Patent Publication No. 466413, titled “Method and apparatus for data communication between computers”, has recently been developed. FIG. 2 schematically illustrates the connection between two USB hosts 22 and 24 via a USB bridge device 20. Unlike the USB connection interface 14 in FIG. 1, the USB bridge device 20 allows the first USB host 22 and the second USB host 24, for example, two personal computers, to communicate with each other so that data transfer can be made therebetween.

Although the USB data storage device 12 in FIG. 1 and the USB bridge device 20 in FIG. 2 are designed with the Plug-and-Play feature, these single-function devices are not flexible in use, and thus do not meet the multi-function trend in information products. The USB mini drive having a flash memory as a storage medium is small and handy, but very limited in capacity. The USB bridge device is shaped as a long cable, which is inconvenient to carry around.

Therefore, there is a need to develop a Plug-and-Play device, which is integrated with the functions of the portable storage device and the bridge device, yet remains handy and suitable to carry around.

### SUMMARY OF THE INVENTION

The object of the present invention is to provide a hot plug/hot swap apparatus for multiple host access to a storage medium, which functions as a storage device when being connected with only one single host and functions as both a storage device and a transfer device when being connected with two or more hosts.

Another object of the present invention is to provide a hot plug/hot swap apparatus for multiple host access to a storage medium, which is designed with a detachable cable and thus is suitable for carrying around and for manipulation.

To achieve the above objects, according to one aspect of the present invention, an apparatus for multiple host access to a storage medium comprises a first hot plug/hot swap interface for interfacing to a first host, a second hot plug/hot swap interface for interfacing to a second host, a storage interface for interfacing to the storage medium, and a control circuit for controlling access to the storage medium from the first host and the second host. When only one of the first host and the second host is effectively interfaced with the apparatus, the storage medium is appended to the effectively interfaced host, and the apparatus provides access to said storage medium from the effectively interfaced host. On the other hand, when both the first host and the second host are effectively interfaced with said apparatus, the storage medium is appended to one of the first host and the second host, and the apparatus provides bridging between the first host and the second host as well as access to the storage medium from both the first host and the second host.

Therefore, if the apparatus for multiple host access to a storage medium is connected to only one host, it may be used as a storage device; if the apparatus for multiple host access to a storage medium is connected to two or more hosts, it may be used as both a storage device and a transfer device for bridging the hosts.

According to another aspect of the present invention, the above apparatus for multiple host access to a storage medium further comprises a first connector and a second connector, with the first hot plug/hot swap interface disposed in the first connector and the second hot plug/hot swap interface disposed in the second connector. Also, the apparatus includes a detachable cable having a third connector at one end and a forth connector at the other end. The first connector is employed for connecting to the first host, allowing the first hot plug/hot swap interface to be interfaced with the first host. The second connector is employed for connecting to the third connector while the forth connector is connected to the second host, allowing the second hot plug/hot swap interface to be interfaced with the second host via the cable.

Therefore, the cable may be detached from the apparatus to enhance the portability thereof without adversely affecting the functions of data storage and data transfer. The cable is a common cable, which can be easily obtained in any places where information facilities exist. With the cable attached, a data transfer between two hosts may be conveniently performed through the apparatus.

### BRIEF DESCRIPTION OF THE DRAWINGS

Objects and advantages of the present invention will be fully understood from the detailed description to follow taken in conjunction with the embodiments as illustrated in the accompanying drawings, wherein:

FIG. 1 schematically illustrates the connection between a conventional USB mini drive and a USB host;

FIG. 2 schematically illustrates the connection between two USB hosts via a USB bridge device;

FIG. 3 is a block diagram of a preferred embodiment according to the present invention;

FIG. 4 is a flow chart for explaining the operation of the preferred embodiment according to the present invention;

FIG. 5 is a state machine showing the switching between a data storage state and a data bridge state in the preferred embodiment according to the present invention; and

FIG. 6 schematically illustrates the structure for implementing the preferred embodiment according to the present invention.

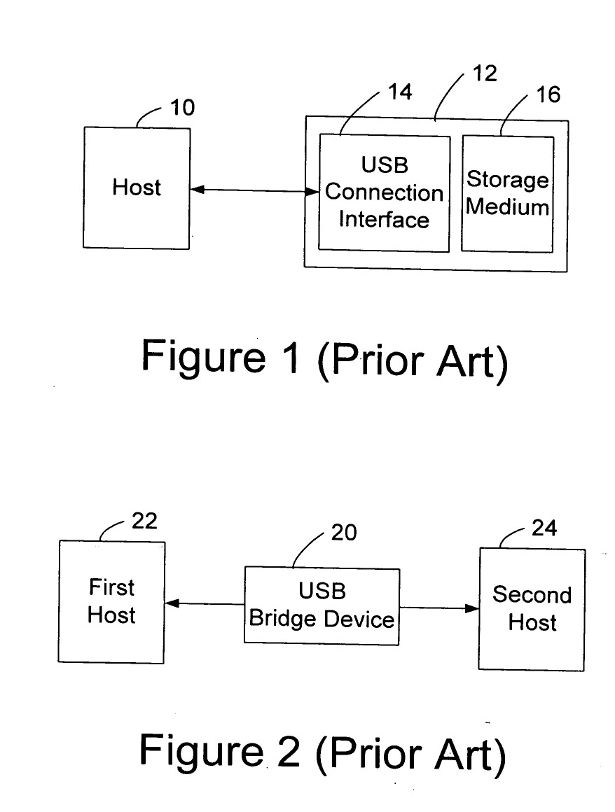

### DETAILED DESCRIPTION OF THE PREFERRED EMBODIMENT

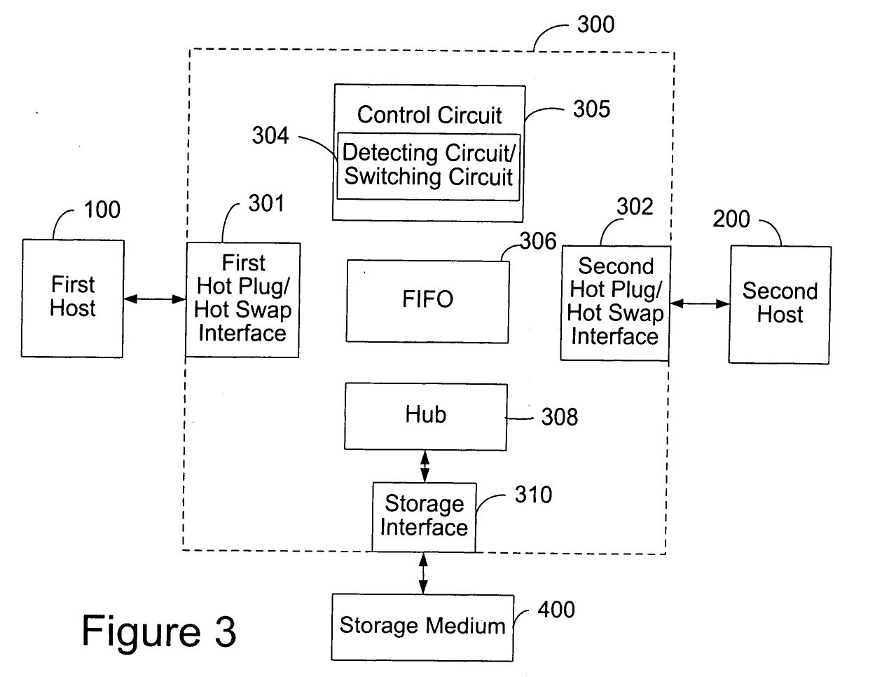

The structure and operation of the apparatus for multiple host access to a storage medium according to the present invention will be exemplified with a USB system in the following description with reference to FIGS. 3 to 6.

FIG. 3 schematically shows a block diagram of a preferred embodiment according to the present invention. As shown, an apparatus 300 for multiple host access to a storage medium comprises a first hot plug/hot swap interface 301 and a second hot plug/hot swap interface 302, which are disposed for interfacing to a first host 100 and a second host 200, respectively. In this embodiment, the first hot plug/hot swap interface 301 and the second hot plug/hot swap interface 302 are both USB interfaces, and the first host 100 and the second host 200 may be any type of devices that support the USB protocol, for example, personal computers, serves, PDAs and cellular phones.

The apparatus 300 also includes a hub 308, which is connected with a storage interface 310 for interfacing to a storage medium 400. The hub 308 may be implemented as a compound device or a composite device. The major difference between a compound device and a composite device is that different ways of specifying addresses are employed in each device. In a compound device where a number of functions are integrated together with a hub, the hub and each of the functions have separate device addresses. By contrast, a composite device having a hub and a number of functions integrated together appears to the system as a single device address. In designing the hub 308, the choice between a compound device and a composite device does not affect the achievement of the invention. Although the hub 308 in FIG. 3 is shown to be only connected with one function, i.e., only connected with the storage medium 400 via the storage interface 310, the hub 308 may also be connected with two or more functions according to the USB specification. In other words, a plurality of storage media may be interfaced to the apparatus 300. The number of the storage medium can be decided depending on demands of a particular design. Desirably, the storage medium 400 is a convention flash memory, but the invention is not limited thereto. Other types of memory, such as SM (Smart Medium) and SD (Secure Digital) memories, micro drives (MDs), and even typical hard disk drives may also be employed as the storage medium 400.

Referring now to FIG. 3, the apparatus 300 for multiple host access to a storage medium further comprises a control circuit 304 and a FIFO (First-in First-out) unit 306. The control circuit 304 includes a USB controller and a circuit for controlling access of the first host 100, the second host 200 and the storage medium 400. The FIFO unit 306 serves as a buffer circuit, which processes data in a “first-in first-out” way, for the data transfer between the first host 100, the second host 200 and the storage medium 400. According to the preferred embodiment of the invention, the control circuit 304 also includes a detecting circuit and a switching circuit 305. The detecting circuit detects the interface states of the first host 100 and the second host 200 to determine, for example, whether the first host 100 is plugged into the first hot plug/hot swap interface 301, whether the second host 200 is plugged into the second hot plug/hot swap interface 302, and whether the interface between the apparatus 300 and the first host 100/the second host 200 is effective. The detecting circuit also detects whether the power supply source of the apparatus 300 is from the first host 100 or from the second host 200 to determine which one of the two hosts 100 and 200 is first interfaced to the apparatus 300. The switching circuit operates to switch the appending of the storage medium 400 to the first host 100 or to the second host 200.

With the above described control circuit 304, when only one of the first host 100 and the second host 200 is effectively interfaced with the apparatus 300, the control circuit 304 controls to append the storage medium 400 to the effectively interfaced host and to allow access of the storage medium 400 from the effectively interfaced host. For example, if the first host 100 is plugged into the first hot plug/hot swap interface 301 while the second host 200 is not plugged into second hot plug/hot swap interface 302, then the storage medium 400 becomes an appended storage device of the first host 100 and the apparatus 300 consumes power from a power supply of the first host 100. In another case, when both the first host 100 and the second host 200 are effectively interfaced with the apparatus 300, the storage medium 400 is controlled to be appended to one of the first host 100 and the second host 200, and the apparatus 300 serves as a bridge device between the first host 100 and the second host 200 and provides access of the storage medium 400 from both the first host 100 and the second host 200. For example, if the first host 100 is originally plugged in the first hot plug/hot swap interface 301 and later the second host 200 is also plugged into the second hot plug/hot swap interface 302, then, as described above, the storage medium 400 is appended to the first host 100 and power supply source of the apparatus 300 is from the first host 100. At this time, the first host 100 and the second host 200 are allowed to access each other, and thus the second host 200 may access data in the appended storage devices, including the storage medium 400, of the first host 100.

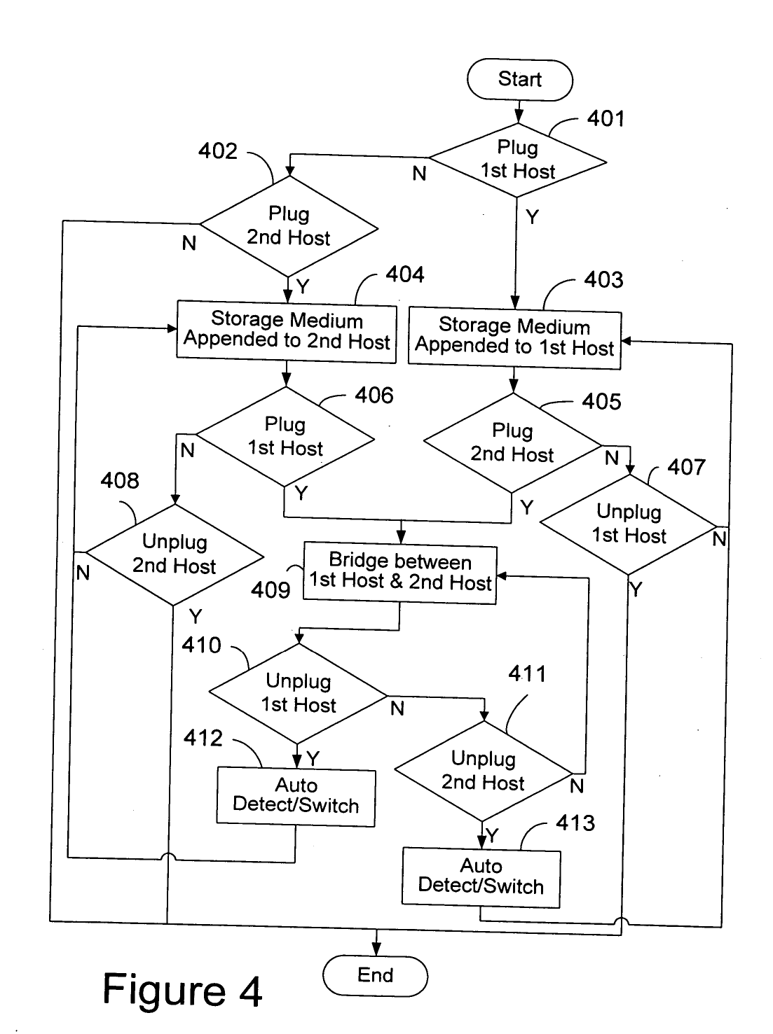

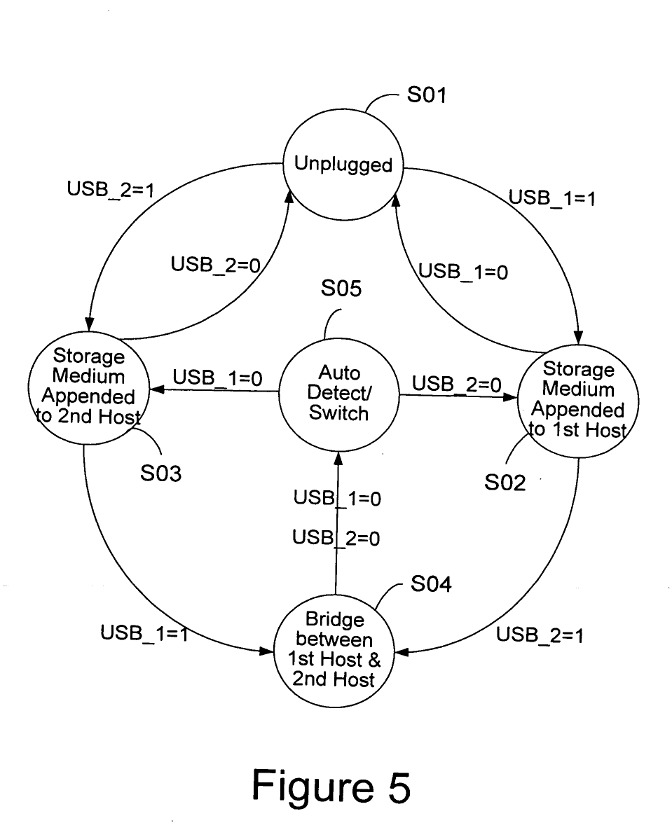

The operation of the apparatus 300 for multiple host access to a storage medium will become more apparent from the flow chart in FIG. 4 and the state machine in FIG. 5. In FIG. 5, the interface states of the first host 100 and the second host 200 are respectively represented by USB_{—}1 and USB_{—}2, where logic “1” means “effectively interfaced” and logic “0” means “not interfaced”.

Initially, the apparatus 300 is not connected with any host; namely, both hosts 100 and 200 are unplugged (state S01). Then, in steps 401 and 402, it is determined whether the first host 100 is plugged into the first hot plug/hot swap interface 301 and whether the second host 200 is plugged into the second hot plug/hot swap interface 302, respectively. If the first host 100 is first plugged in, then the operation proceeds to step 403 that the storage medium 400 becomes appended to the first host 100 (state S02). On the other hand, if the second host 200 is first plugged in, then the operation proceeds to step 404 that the storage medium 400 becomes appended to the second host 200 (state S03). Next, in the case that the first host 100 is first plugged in (step 403), it is further determined in steps 405 and 407 whether the second host 200 is plugged into the second hot plug/hot swap interface 302 and whether the first host 100 is unplugged from the first hot plug/hot swap interface 301, respectively. In step 407, if it is detected that the first host 100 stays plugged in, then the system remains in state S02; otherwise, if the first host 100 is unplugged, then the operation ends and the system is restored to state S01. In step 405, if it is detected that the second host 200 is plugged into the second hot plug/hot swap interface 302, then the operation proceeds to step 409 that the apparatus 300 becomes a bridge device between the first host 100 and the second host 200 (state S04). On the other hand, in the case that the second host 200 is first plugged in (step 404), it is further determined in steps 406 and 408 whether the first host 100 is plugged into the first hot plug/hot swap interface 301 and whether the second host 200 is unplugged from the second hot plug/hot swap interface 302, respectively. In step 408, if it is detected that the second host 200 stays plugged in, then the system remains in state S03; otherwise, if the second host 200 is unplugged, then the operation ends and the system is restored to state S01. In step 406, if it is detected that the first host 100 is plugged into the first hot plug/hot swap interface 301, then the operation proceeds to step 409 that the apparatus 300 becomes a bridge device between the first host 100 and the second host 200 (state S04). Hence, in state S04, the storage medium 400 is either appended to the first host 100 or appended to the second host 200, depending on whether the previous state is S02 or S03.

Then, in the state that both the first host 100 and the second host 200 are plugged in (state S04 or step 409), it is further determined in steps 410 and 411 whether the first host 100 is unplugged from the first hot plug/hot swap interface 301 and whether the second host 200 is unplugged from the second hot plug/hot swap interface 302, respectively. As it is determined in step 410 that the first host 100 is unplugged from the first hot plug/hot swap interface 301, if the storage medium 400 is previously appended to the first host 100, i.e., in state S02, a power supply source change will be detected (state S05) in step 412 and the storage medium 400 will be switched to be appended to the second host 200, i.e., back to step 404 (state S03). On the other hand, as it is determined in step 411 that the second host 200 is unplugged from the second hot plug/hot swap interface 302, if the storage medium 400 is previously appended to the second host 200, i.e., the state of S03, a power supply source change will be detected (state S05) in step 413 and the storage medium 400 will be switched to be appended to the first host 100, i.e., back to step 403 (state S02).

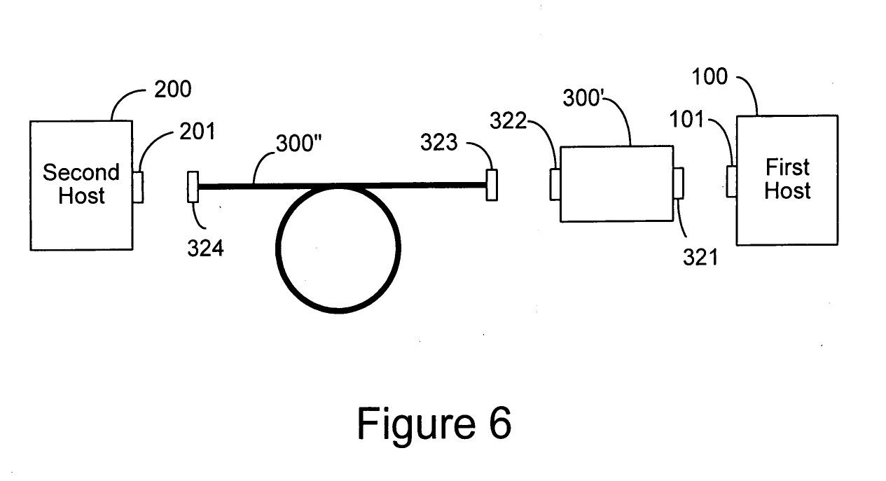

FIG. 6 schematically illustrates the structure for implementing the preferred embodiment according to the present invention. In order to provide an apparatus having both the functions of data storage and data transfer while being handy and convenient to carry around, when designing a product for commercializing the invention, the apparatus 300 is separated into a transfer/storage apparatus 300′ and an extension cable 300″. The circuit of the above described apparatus 300 is incorporated in the transfer/storage apparatus 300′, and a first connector 321 and a second connector 322 are respectively provided at the first hot plug/hot swap interface 301 and the second hot plug/hot swap interface 302. The extension cable 300″ is a cable having a predetermined length, with a third connector 323 provided at one end and a forth connector 324 provided at the other end. The first connector 321 of the transfer/storage apparatus 300′ is adapted to be plugged into the connector 101 of the first host 100, while the second connector 322 of the transfer/storage apparatus 300′ is adapted to connect to the third connector 323 at one end of the extension cable 300″ and thus to the connector 201 of the second host 200 through the forth connector 324 at the other end of the extension cable 300″. Thereby, the first host 100 and the second host 200 may respectively be interfaced to the first hot plug/hot swap interface 301 and the second hot plug/hot swap interface 302.

The separable design described above is advantageous for two reasons. First, the extension cable 300″ may be detached so that the transfer/storage apparatus 300′ becomes a handy mini drive. Second, with the extension cable 300″ attached, the transfer/storage apparatus 300′ is convenient to be used for bridging two hosts. Moreover, the extension cable 300″ is a conventional cable, such as a USB AB cable, and thus a cable of the same type can be easily obtain if an user does not carry one.

Although the structure and operation of the apparatus for multiple host access to a storage medium have been explained above in an USB system having two hosts, it should be considered as only illustrative, not restrictive. The apparatus of the present invention may also be designed with three or more hot plug/hot swap interfaces for applying to a system having three or more hosts.

Moreover, although the preferred embodiment of the invention is exemplified with a USB system, the same concept may also apply to an IEEE 1394 system or other hot plug/hot swap systems. However, it should be understood by persons skilled in this art that a hub is absent in an apparatus using IEEE 1394 protocol.

While the present invention has been described with reference to the preferred embodiments thereof, it is to be understood that the invention should not be considered as limited thereby. Various modifications and changes could be conceived of by those skilled in the art without departuring from the scope of the present invention, which is indicated by the appended claims.

1. An apparatus for multiple host access to a storage medium, comprising:
a first hot plug/hot swap interface for interfacing to a first host;
a second hot plug/hot swap interface for interfacing to a second host;
a storage interface for interfacing to said storage medium; and
a control circuit for controlling access to said storage medium from said first host and said second host, so that, when only one of said first host and said second host is effectively interfaced with said apparatus, said storage medium is appended to said effectively interfaced host and said apparatus provides access to said storage medium from said effectively interfaced host, and when both said first host and said second host are effectively interfaced with said apparatus, said storage medium is appended to one of said first host and said second host and said apparatus provides bridging between said first host and said second host as well as access to said storage medium from both said first host and said second host.

2. The apparatus for multiple host access to a storage medium of claim 1, wherein when both said first host and said second host are effectively interfaced with the apparatus, said storage medium is appended to the first effectively interfaced one of said first host and said second host.

3. The apparatus for multiple host access to a storage medium of claim 1, wherein said control circuit comprises a detecting circuit for detecting interface states of said first host and said second host and a switching circuit for switching the appending of said storage medium to said first host or to said second host.

4. The apparatus for multiple host access to a storage medium of claim 1, wherein said first hot plug/hot swap interface and said second hot plug/hot swap interface are USB (Universal Serial Bus) interfaces.

5. The apparatus for multiple host access to a storage medium of claim 1, wherein said first hot plug/hot swap interface and said second hot plug/hot swap interface are IEEE 1394 interfaces.

6. The apparatus for multiple host access to a storage medium of claim 1, wherein said storage medium is a mass storage device.

7. The apparatus for multiple host access to a storage medium of claim 1, wherein said storage medium is a memory device.

8. The apparatus for multiple host access to a storage medium of claim 1, wherein said storage medium is a hard disk drive.

9. The apparatus for multiple host access to a storage medium of claim 1, further comprising a FIFO (First-in First-out) unit.

10. An apparatus for multiple host access to a storage medium, comprising:
a plurality of hot plug/hot swap interfaces for respectively interfacing to a plurality of hosts;
at least one storage interface for interfacing to at least one storage medium; and
a control circuit for controlling access to said at least one storage medium from said plurality of hosts, so that, when only one of said plurality of hosts is effectively interfaced with said apparatus, said at least one storage medium is appended to said effectively interfaced host and said apparatus provides access to said at least one storage medium from said effectively interfaced host, and when two or more of said plurality of hosts are effectively interfaced with said apparatus, said at least one storage medium is appended to one of said effectively interfaced hosts and said apparatus provides bridging between said effectively interfaced hosts as well as access to said at least one storage medium from said effectively interfaced hosts.

11. The apparatus for multiple host access to a storage medium of claim 10, wherein, said apparatus comprises a plurality of storage interfaces for interfacing to a plurality of storage media.

12. The apparatus for multiple host access to a storage medium of claim 10, wherein, when two or more of said plurality of hosts are effectively interfaced with said apparatus, said at least one storage medium is appended to the first effectively interfaced one of said effectively interfaced hosts.

13. The apparatus for multiple host access to a storage medium of claim 10, wherein, said control circuit comprises a detecting circuit for detecting interface states of said plurality of hosts and a switching circuit for switching the appending of said at least one storage medium to said plurality of hosts.

14. The apparatus for multiple host access to a storage medium of claim 10, wherein, said plurality of hot plug/hot swap interfaces are USB (Universal Serial Bus) interfaces.

15. The apparatus for multiple host access to a storage medium of claim 10, wherein, said plurality of hot plug/hot swap interfaces are IEEE 1394 interfaces.

16. The apparatus for multiple host access to a storage medium of claim 10, wherein, said at least one storage medium is a mass storage device.

17. The apparatus for multiple host access to a storage medium of claim 10, wherein, said at least one storage medium is a memory device.

18. The apparatus for multiple host access to a storage medium of claim 10, wherein, said at least one storage medium is a hard disk drive.

19. The apparatus for multiple host access to a storage medium of claim 10, further comprising a FIFO (First-in First-out) unit.

20. An apparatus for multiple host access to a storage medium, comprising:
a first connector for connecting to a first host, said first connector including a first hot plug/hot swap interface for interfacing to a first host;
a second connector including a second hot plug/hot swap interface for interfacing to a second host;
a cable having at one end a third connector for connecting to said second connector and at the other end a forth connector for connecting to said second host;
a storage interface for interfacing to said storage medium; and
a control circuit for controlling access to said storage medium from said first host and said second host, so that, when only one of said first host and said second host is effectively interfaced with said apparatus, said storage medium is appended to said effectively interfaced host and said apparatus provides access to said storage medium from said effectively interfaced host, and when both said first host and said second host are effectively interfaced with said apparatus, said storage medium is appended to one of said first host and said second host and said apparatus provides bridging between said first host and said second host as well as access to said storage medium from both said first host and said second host.

21. The apparatus for multiple host access to a storage medium of claim 20, wherein said first, second, third and forth connectors are USB (Universal Serial Bus) connectors.

22. The apparatus for multiple host access to a storage medium of claim 20, wherein said first, second, third and forth connectors are IEEE 1394 connectors.
